(19) United States
(12) Patent Application Publication
(10) Pub. No.: US 2022/0097259 A1
(43) Pub. Date: Mar. 31, 2022

(54) SINGLE EXTRUDER BARREL DESIGN TO ACCOMMODATE COMPOUNDING, CHEMICAL REACTIONS, AND IMMISCIBLE POLYMER BLENDS WITH SOLIDS COATED BY ONE OF THE POLYMERS

(71) Applicant: Rutgers, The State University of New Jersey, New Brunswick, NJ (US)

(72) Inventors: Thomas J. Nosker, Stockton, NJ (US); Arya S. Tewatia, Piscataway, NJ (US)

(73) Assignee: Rutgers, The State University of New Jersey, New Brunswick, NJ (US)

(21) Appl. No.: 17/418,100

(22) PCT Filed: Jan. 7, 2020
(86) PCT No.: PCT/US2020/012563

§ 371 Date: Jun. 24, 2021

Related U.S. Application Data
(60) Provisional application No. 62/789,290, filed on Jan. 7, 2019.

(51) Int. Cl. B29B 7/42; B29B 7/90

(52) U.S. Cl. CPC B29B 7/429; B29K 2101/12; B29B 7/90

(57) ABSTRACT

A multi-port single screw extruder combining a heated plastication barrel having a first entrance port and an exit port on opposing ends of the barrel and a second entrance port intermediately positioned therebetween; a first hopper positioned to deliver ingredients to the first entrance port of said barrel; a second hopper positioned to deliver ingredients to the second entrance port and a helical plastication screw rotatably carried within the barrel and running the length thereof between the first entrance port and exit port that is operable to rotate and transmit the ingredients along the length of the barrel; wherein the plastication screw includes a distributive mixing element located between at least one additional entrance port and the exit port, the minor diameter of the plastication screw is reduced in advance of each additional entrance port sufficient to reduce the barrel pressure at each entrance port to a level that permits the addition of ingredients to the barrel through the entrance port, and the ingredients include a thermoplastic polymer.

### CLAIM OF PRIORITY

This application is a U.S. Non-Provisional patent application and claims priority to U.S. Provisional Patent Application No. 62/789,290, filed Jan. 7, 2019, incorporated herein by reference in its entirety.

### BACKGROUND OF THE INVENTION

Dispersing and distributing pigment, modifiers, filler, particles, reinforcing agents, and other various compounds within a polymer matrix for injection molding are difficult. In most cases, twin screw extrusion (TSE) is commonly used for pre-compounding in order to achieve good mixing. However, single screw extrusion (SSE) offers several advantages, including lower cost, rugged machinery more resistant to abuse, easy and inexpensive part replacement, widely available new or used equipment, easy operation, lower back pressures, and the ability to combine compounding and final product extrusion as a single operation.

Industrial SSE use has lagged because extruders with single screw flights have lacked the multiple elongational flow fields of multi-screw extruders (MSE), which provide simple upstream axial mixing and the ability to degas during mixing. To achieve good dispersion, surface treatments are employed with SSE to promote wetting by the polymer but have not been fully successful nor duplicated the effect of mixing alone achieved with multi-screw extruders. Controlled feeding/melting mechanisms are used with SSE to decrease agglomerate formation and reduce the dispersion necessary for good mixing. To enhance distributive mixing, starve feeding may be used, if the polymer is not subject to degradation. SSE is intrinsically limited in dispersive and distributive mixing but good dispersion can often be achieved by using specialized additives, whereas distributive mixing can equal any MSE com-pounder with retro-fitted mixing devices. The function of SSE has changed from only plasticating to both plasticating and mixing, achievable by adding a mixing element to the screw.

There are several types of mixing elements suitable for SSE, each with their own advantages and disadvantages. For homogeneity, a combination of both dispersive and distributive mixing is optimal, specifically dispersion followed by distribution. There are no standardized ways to evaluate the compounding ability of a mixer because this will vary with the additives being compounded. For example, it is difficult to quantitatively measure dispersion of filler particles in heavily filled thermoplastics. Comparative studies have been performed in which different types of mixing elements are investigated to improve mixing of hybrid materials systems in SSE. And, there have been attempts to reduce manufacturing costs by improving the compounding role of SSE used in final product manufacture, specifically examining powders in polyolefins and typical liquid additives in various polymers. However SSE is still considered generally unsuitable for dispersive mixing of powders and liquids into polymers.

TSE/MSE have been set up with a multitude of inlet ports, to accommo-date adding various fillers to plastics during processing, resulting in many different varieties of filled resin for various industrial and end use markets. In contrast, single screw extruders have all typically had only one inlet port, and perhaps a vent.

There remains a need for an SSE capable of accommodating various fillers to plastics during processing, resulting in many different varieties of filled resin for various industrial and end use markets.

### SUMMARY OF THE INVENTION

This need is met by the present invention. It has now been discovered that a single screw extruder can accommodate multiple inlet ports, rather than the more typical single inlet port, to facilitate a number of operations previously not considered to be carried out in a single screw extruder.

Therefore, according to one aspect of the present invention, a single screw extruder plastication unit is provided having a heated plastication barrel including a first entrance port and an exit port on opposite ends of the barrel and at least one additional entrance port therebetween; multiple hoppers positioned to deliver ingredients to be compounded to each of the entrance ports of the barrel; and a helical plastication screw rotatably carried within the barrel between the first entrance port and the exit port, which is operable to rotate, disperse and transmit the ingredients along the length of the barrel; wherein:

(a) the plastication screw includes at least one distributive mixing element located between at least one additional entrance port and the exit port;

(b) the minor diameter of the plastication screw is reduced in advance of each additional entrance port sufficiently to reduce the barrel pressure at each entrance port to a level that permits the addition of ingredients to the barrel through the entrance port, and

(c) the ingredients include at least one thermoplastic polymer.

According to one embodiment, the plastication barrel has one additional entrance port fed by a hopper and the plastication screw has one distributive mixing element located between the additional entrance port and the exit port.

Embodiments are provided in which the plastication screw contains a plurality of elements for mixing and conveying the ingredients to be compounded and injection molded. In one embodiment, the plastication screw includes a conveyor segment positioned to receive and disperse the ingredients to be compounded from one or more of the hoppers and to convey the ingredients to the distributive mixing element segment. In another embodiment, the plastication screw further includes a second conveyor segment positioned to receive the compounded ingredients from the mixing element segment and to convey the compounded ingredients along the barrel in the direction of the exit port.

In another embodiment, the plastication barrel includes a second entrance port and corresponding hopper and a second distributive mixing element between the second entrance port and the exit port, and the second conveyor segment conveys the compounded ingredients from the first distributive mixing element to the second distributive mixing element. In another embodiment, one distributive mixing element delivers the compounded ingredients directly to another distributive mixing element.

In another embodiment, two additional entrance ports are provided with corresponding hoppers and one additional distributive mixing elements between the two additional entrance ports and the exit port. Additional entrance ports with corresponding hoppers can also be provided that do not precede a distributive mixing element and serve to deliver ingredients that are dispersed by a plastication screw segment. Additional embodiments with more entrance ports, liquid/gas injection ports, vents, hoppers, conveyor segments and distributive mixing elements are also provided by the present invention. Furthermore, the plurality of elements in the foregoing embodiments are configured on a single plastication screw driven by a single drive motor.

According to one embodiment, the distributive mixing element is config-ured to provide recirculating high elongational flow to the compounded ingredients. According to another embodiment, the distributive mixing element is an axial fluted extensional mixing element. Distributive mixing element length to diameter ratios will vary depending on the ingredients to be compounded with the polymer.

The present invention further incorporates the discovery that ingredients to be compounded can be thoroughly mixed within a single screw extruder by including one or more distributive mixing elements with a short length to diameter ratio on the plastication screw, making it possible to configure a single screw extruder with one or more distributive mixing elements to compound thermoplastic polymer composites. Each distributive mixing element receives ingredients from a correspond-ing entrance port with a corresponding hopper, with each distributive mixing element positioned between its entrance port and the exit port.

According to one embodiment, the distributive mixing element segments have a length to diameter ratio (L/D) of less than 30:1. In a more specific embodi-ment, distributive mixing element segments have an L/D between 12:1 and 30:1.

According to one embodiment, the plastication screw between the first two entrance ports has an L/D of at least 12:1. According to a more specific embodi-ment, this plastication screw has an L/D of at least 30:1. The L/D can be as high as 50:1, i.e., between about 24:1 and about 50:1

Configuring the plastication screw with one or more distributive mixing element segments fed by additional hoppers makes it possible to deliver ingredients to mix in stages. According to one embodiment, the plastication barrel of the extruder further includes two additional entrance ports positioned to deliver the same or differ-ent additional ingredients to be compounded either to a second conveyor segment for delivery to a second distributive mixing element segment, or directly to a second distributive mixing element segment. In another embodiment, two additional hoppers are positioned to deliver additional ingredients to two additional entrance ports.

The plastication unit of the present invention can be retrofitted to existing injection molding systems. According to another aspect of the present invention, new and retrofitted injection molding machines are provided, incorporating the plastication unit of the present invention. Suitable injection molding systems to which the extru-ders of the present invention can be adapted are disclosed in U.S. Pat. No. 9,533,432, the disclosure of which is incorporated herein by reference.

The plastication unit of the present invention makes possible the corn-pounding of thermoplastic polymer composite compositions. Therefore, according to another aspect of the present invention, polymer compounding methods are provided that include the steps of:
feeding a thermoplastic polymer to the first entrance port of the plastication unit of the present invention, wherein the barrel of the unit is heated above the compounding temperature of the polymer;
transmitting the polymer along the length of the heated barrel to the distributive mixing element with the plastication screw of the plastication unit, wherein the polymer is heated to a flowable state for mixing;
adding one or more additional ingredients to the polymer through an additional entrance port; and
subjecting the polymer and additional ingredients to a series of successive shear-strain events with the distributive mixing element to form a uniform homogenous flowable mass of a composition with a microscale mor-phology having structures with a major axis less than one micron long.

According to one embodiment, the flowable mass is directly delivered from the exit port of the barrel of the plastication unit into a mold cavity and a molded article is formed. According to another embodiment, the flowable mass is forced through a die to form continuous string or ribbon structures that are cooled and chopped into bulk particles for subsequent melting and processing.

The blend of ingredients that is compounded and promptly injected into a mold cavity are known injection molding polymers and additives. In one embodiment, the blend of ingredients includes a thermoplastic polymer. In another embodiment, the blend of ingredients includes a blend of two or more polymers. In another multi-polymer embodiment, two or more polymers are immiscible. In yet another embodi-ment, the blend of ingredients includes at least one polymer for injection molding and one or more compounding additives. According to a more specific embodiment, the compounding additives are independently selected from pigments, colorants, modi-fiers, fillers, particles and reinforcing agents. In an even more specific embodiment, the reinforcing agents are reinforcing fibers. Most specifically, the reinforcing fibers are glass fibers.

In another embodiment, the additional ingredient is graphite and the series of successive shear-strain events exfoliates the graphite to form a polymer composite containing mechanically exfoliated graphene. Varying the duration of distributive mixing will determine the degree of graphene exfoliation and the amount of residual graphite remaining in the polymer composite.

According to another aspect of the present invention, thermoplastic polymer compositions prepared by the method of the present invention are provided. According to another embodiment, formed plastic articles are provided, prepared from the thermoplastic polymer compositions of the present invention.

A more complete appreciation of the invention and many other intended advantages can be readily obtained by reference to the following detailed description of the invention and claims in conjunction with the accompanying drawings.

### BRIEF DESCRIPTION OF THE DRAWINGS

FIG. 1 is a diagram of a two input port single screw extruder;

FIG. 2 is a diagram of a three input port single screw extruder;

FIG. 3 is a side elevation showing an axial fluted extensional mixing element in accordance with the invention; and

FIG. 4 is a sectional view of the axial fluted extensional mixing element of FIG. 3.

### DETAILED DESCRIPTION OF THE INVENTION

The present invention modifies a single screw compounding extruder with one or more distributive mixing elements to provide a high throughput means by which thermoplastic polymer composites can be manufactured with microscale and nanoscale morphologies. The distributive mixing element creates an elongational flow field, upstream axial mixing, and thin film degassing.

When the distributive mixing element is an axial fluted extensional mixing element (AFEM), the open flutes in the AFEM do not require high pressure and allow material flow to leave the mixer to continue down the length of the screw or to re-enter another flute and “recirculate” within the mixer again. This design feature has a profound influence on shear flow, degree of distributive mixing, and resulting mixed-ness and morphology. The attributes result in enhanced mixing of a variety of material systems, including polymer blends and polymer-based composite materials. One example of a suitable AFEM is disclosed in U.S. Pat. No. 6,962,431, the contents of which are herein incorporated by reference.

The present invention incorporates the discovery that distributive mixing of thermoplastic polymer particles with other particulate ingredients improves when introduction is delayed until the polymer is heated to a flowable state for distributive mixing. The present invention positions entrance ports for delivery of particulate ingredients at locations upstream of distributive mixing elements, where the polymer has received sufficient heat over time to be in a flowable state for distributive mixing.

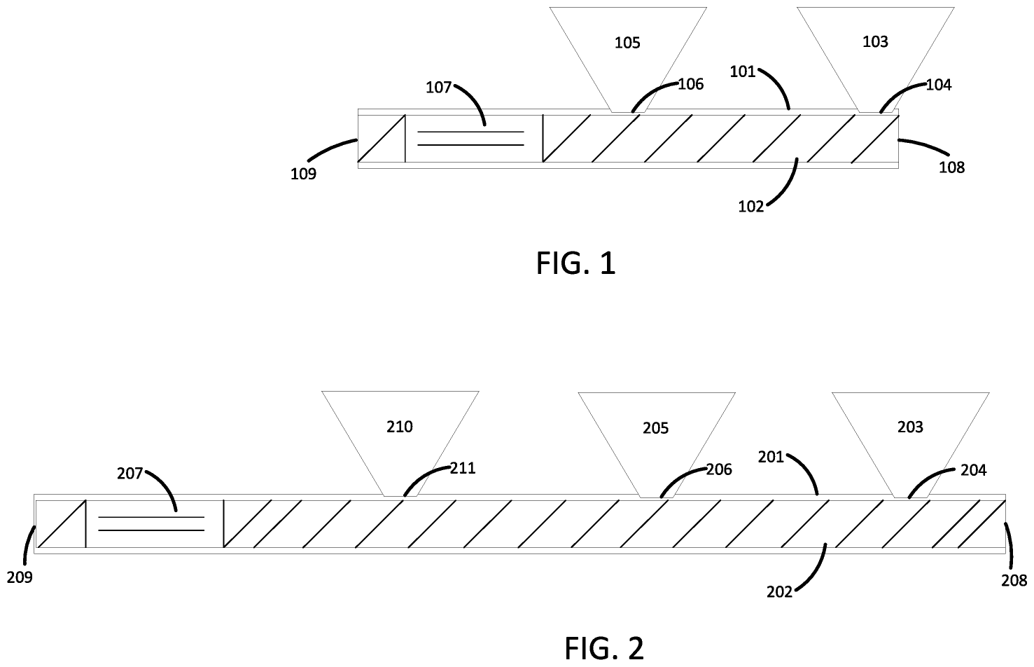

Referring to FIG. 1, an example two entrance port single screw extruder is shown. A plasitcation barrel 101 has an inlet end 108 and an exit end or port 109. Hoppers 103 and 105 feed material into entrance ports 104 and 106. Plastication screw 102 rotates and transmits material fed from hoppers 103 and 105 through entrance ports 104 and 106 to the exit end or port 109. Mixing element 107 is positioned between hopper 105 and port 106 and the exit end or port 109. The minor diameter of plastication screw 102 is reduced (not shown) just before entrance port 106 to drop the barrel pressure and permit the addition of ingredients. According to various embodiments, the inlet end or port 108 and the exit end or port 109 are aligned center-to-center with the plastication barrel 101. According to other embodiments, one or more of the inlet end or port 108 and the exit end or port 109 are not aligned center-to-center with the plastication barrel 101, but are rather offset from the center of the plastication barrel 101. Depending on the bulk density of the feed materials, there may be an advantage to offset the center of the ports/ends 108,109, relative to the screw 102, in the direction of motion of the top of the screw 102, as viewed from above. This has the function of squeezing the material into the flow of the material in the extruder flights, using the force of the rotating screw 102.

Referring to FIG. 2, an example three entrance port single screw extruder is shown. A plasitcation barrel 201 has an inlet end 208 and an exit end or port 209. Hoppers 203, 205, and 210 feed material into entrance ports 204, 206, and 211, respectively. Plastication screw 202 rotates and transmits material fed from hoppers 203, 205 and 210 through entrance ports 204, 206, and 211 to the exit end or port 209. Mixing element 207 is positioned between hopper 210 and port 211 and the exit end or port 209. The minor diameter of plastication screw 202 is reduced (not shown) just before entrance ports 206 and 211 to drop the barrel pressure and permit the addition of ingredients.

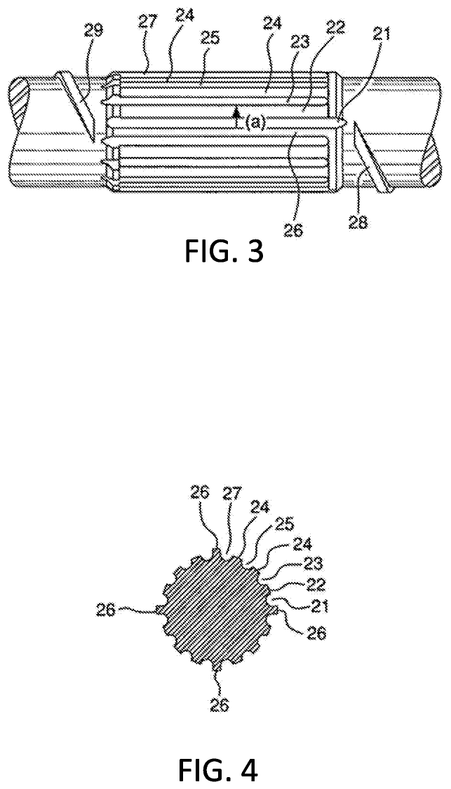

Referring to FIGS. 3 and 4, an axial fluted extensional mixing element suitable for use with the invention comprises an inlet channel 21, conveying material to a first cross-axial pump 22. Cross-axial pump 22 reorients the material in planar shear while pumping into intermediate channel 23. Intermediate channel 23, which is in fluid communication with inlet channel 21, conveys material to subsequent cross-axial pump 24, where subsequent acceleration and further mixing takes place. Subsequent cross-axial pump 24 further reorients the material in planar shear while pumping material to subsequent intermediate channel 25, which is in fluid communi-cation with intermediate channel 23. After subsequent mixing and pumping, material is delivered to outlet channel 27, which is in fluid communication with intermediate channel 25. The cross-axial pumps 22 and 24 pump mixture at an angle (FIGS. 3 and 4), and draw off the material from the channels 21, 23, 25 till the supply is exhausted.

Any single thermoplastic polymer or thermoplastic polymer blend (e.g. two or more polymers) suitable for use in a compounding extruder can be used in the present invention. For purposes of the present invention, thermoplastic polymers are defined as polymers that soften or liquefy on heating and solidify when cooled and can be repeatedly softened and liquefied on exposure to heat.

Blends of thermoplastic polymers can also be used in the present inven-tion. Exemplary polymeric starting materials and amounts for use in the methods of the present invention include those disclosed in U.S. Pat. Nos. 5,298,214 and 6,191,228 for blends of a high-density polyolefin and polystyrene, U.S. Pat. Nos. 5,789,477 and 5,916,932 for blends of a high-density polyolefin and thermoplastic-coated fiber materials, U.S. Pat. No. 8,629,221 for blends of high-density polyolefin (e.g. high density polyethylene) and acrylonitrile-butadiene-styrene and/or polycarbonate, and U.S. Pat. No. 8,008,402 for blends of a high-density polyolefin and poly(methyl meth-acrylate. The disclosures of all six patents are incorporated herein by reference.

Additional polymeric starting materials useful in the present invention include those disclosed in U.S. Pat. Nos. 4,663,388; 5,030,662; 5,212,223; 5,615,158 and 6,828,372. The contents of all five patents are incorporated herein by reference.

Conventional compounding additives can be combined with polymer prior to extrusion. Suitable additives for the polymers or polymer-based composite materials include pigments, colorants, modifiers, fillers, particles, reinforcing agents (e.g. fiberglass), and the like.

The single screw extruders of the present invention can also be used to distributively mix graphite with thermoplastic polymers until it exfoliates to form graphene-polymer matrix composites as disclosed in U.S. Pat. No. 9,896,565 and U.S. Publication Nos. 2016/0083552 and 2017/0218141. The disclosures of all three publications are incorporated herein by reference.

Output from the extruder can be used to fabricate polymer components or added to neat polymer in a standard compounding mixer. For example, colorant or pigment can be combined with one or more polymers using the method of the present invention to prepare a masterbatch that is later added to neat polymer prior to inject-ion molding or other thermoforming processes with the neat polymer. As another example, graphite can be combined with one or more polymers using the method of the present invention to prepare a graphene-polymer matrix composite masterbatch that is later added to neat polymer prior to thermoforming. The graphene matster-batch can also be added to thermosetting polymer phases, polymer emulsions and other formulations where addition of mechanically exfoliated graphene is desired.

The following non-limiting examples set forth herein below illustrate certain aspects of the invention.

### Examples

### Two Inlet Ports—Embodiment One

When polymer pellets are dropped into the mouth of any extruder, the motive forces pushing the pellets into the screw are the friction between the barrel and screw flight, with energy provided by the rotating screw. If one tries to drop graphite crystals into the first port (e.g., entrance port 104) with polymer pellets, the amount of graphite that can actually be transported is very limited, because the graphite exfoliates against both the barrel wall and the screw flights and functions as a lubricant, limiting the degree of exfoliation and homogenous dispersion.

Placing a second port (e.g., entrance port 106) at least 12 L/D (length-to-diameter ratio) down the screw from the first feed port (e.g., entrance port 104), provided room to plasticate the polymer alone, and then drop the barrel pressure to allow graphite to enter the extruder, where it was carried down the screw along with the now sticky, molten polymer to the distributive mixing element where it was further processed.

In a specific example, high density polyethylene (HDPE) was the polymer placed in the first inlet port with processing temperatures ranging from 350-400° F., a screw rotation of 200 rpm, graphite processing ratios of 35% of the resulting composite and a throughput of 10 lbs/hr.

### Two Inlet Ports—Embodiment Two

Two ports can be used to coat particles with one polymer, after which a second polymer is introduced to the melt. This forms an immiscible polymer blend of two polymers, one of which is filled with particles.

In this example 25 wt. % glass fibers are first dry-mixed with polypropyl-ene (PP) and then fed to the first entrance port via the first hopper of the extruder of the present invention, where the plastication screw disperses the glass fibers in the PP while at the same time melting the polymer.

HDPE: is fed through a second port at least 12 L/D down the screw, a location where the PP is sufficiently plasticated and the particles are thoroughly dispersed. The two polymers are then advanced by the plastication screw to the distributive mixing element where a series of successive shear-strain events to form a microstructure consisting of an immiscible polymer blend of two polymers, one of them filled by glass fibers. The second added polymer will remain essentially unfilled. The blend can now be further processed.

Between the first and second inlet ports, the first 6 L/D will have a barrel temperature of 390-440 T and the second 6 L/D a barrel temperature of 390-470° F., with all proceeding zones having barrel temperatures of 370-440 T at 100 rpm.

### Two Inlet Ports—Embodiment Three

A controlled macroporous structure using unwashed resin is produced.

A vent port is placed at least 12 L/D down the screw, providing room to plasticate the polymer and vent contaminants such as water that are volatile at barrel temperatures. A second inlet port is then placed an additional 4 or greater L/D after the vent for additives that can be carried down the screw for further processing, as in the first two embodiments.

In this embodiment, the processing temperature must be sufficiently high to melt the polymer, using HDPE for example, the barrel temperature in the first 6 L/D ranges from 350-400° F., with the temperatures of the second 6 L/D and subse-quent zones ranging from 370-440 T. Over a series of batches, additives in the second inlet include a combination of a time and temperature release foaming agent, with or without other additives for mechanical reinforcement or functionality such as flame retardants, where mixing of the foaming agent after the second inlet port results in a controlled microporous structure.

### Three Inlet Ports—Embodiment Four

The first two embodiments are performed using an extruder with two additional entrance ports at least 12 L/D apart above, where the ingredients are fed by the first two entrance ports, into the extruder and, after further processing, other additives, such as antioxidants, processing aids, or stabilizers, are fed by the third entrance port. Then, another at least 12 L/D is needed to pump these materials out of the single screw extruder.

An example of this embodiment consists of 65 wt. % polystyrene (PS) and glass and 35 wt. % HDPE added at the first and second inlet respectively with barrel temperatures in the first 6 L/D of 350-400° F., temperatures of the second 6 L/D of 390-440° F., and the subsequent zones after the second inlet port having a temperature range of 370-440° F. The third inlet port is used to add additional hollow glass microspheres, to reduce density. Inserting the relatively fragile glass microspheres in the third port reduces the percent breakage of this component.

The foregoing examples and description of the preferred embodiment should be taken as illustrating, rather than as limiting, the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

1. A multi-port single screw extruder, comprising:
a heated plastication barrel having a first end and a second end positioned opposite the first end, the heated plastication barrel including:
a first entrance port;
an exit port,
wherein the first entrance port is positioned on the first end, and
wherein the exit port is positioned on the second end; and
at least one secondary entrance port positioned between the first entrance port and the exit port;
a plurality of hoppers configured to deliver one or more ingredients to each of the first entrance port and the at least one secondary entrance port; and
a helical plastication screw positioned within the heated plastication barrel between the first entrance port and the exit port,
wherein the helical plastication screw is configured to rotate around a central axis, and
wherein the helical plastication screw is configured to transport and disperse the one or more ingredients along the length of the heated plastication barrel when rotating around the central axis.

2. The multi-port single screw extruder of claim 1,
wherein the helical plastication screw has a dynamic minor diameter along a length of the helical plastication screw, and
wherein the minor diameter is reduced in advance of each of the at least one secondary entrance ports, reducing a barrel pressure at each of the at least one secondary entrance ports, permitting the one or more ingredients to be fed into each of the at least one secondary entrance ports.

3. The multi-port single screw extruder of claim 1, wherein the one or more ingredients includes one or more thermoplastic polymers.

4. The multi-port single screw extruder of claim 1, wherein the one or more ingredients includes one or more compounding additives which comprise one or more of the following:
pigments; colorants; modifiers; fillers; particles; and reinforcing agents.

5. The multi-port single screw extruder of claim 1, wherein the helical plastication screw includes a conveyor segment configured and positioned to receive and disperse the one or more ingredients from the plurality of hoppers.

6. The multi-port single screw extruder of claim 1, wherein the heated plastication barrel further includes:
a distributive mixing element positioned between one of the at least one secondary entrance ports and the exit port.

7. The multi-port single screw extruder of claim 6, wherein the helical plastication screw further includes a conveyor segment configured to receive one or more ingredients from the distributive mixing element.

8. The multi-port single screw extruder of claim 7, wherein the conveyor segment is further configured to convey the one or more ingredients along a length of the heated plastication barrel in a direction towards the exit port.

9. The multi-port single screw extruder of claim 6, wherein the distributive mixing element has a length and a diameter, and has a length to diameter ratio up to approximately 30:1.

10. The multi-port single screw extruder of claim 1, wherein the at least one secondary entrance port includes a plurality of secondary entrance ports, and
wherein the heated plastication barrel further includes:
a first distributive mixing element positioned between one of the plurality of secondary entrance ports and the exit port; and
one or more secondary distributive mixing elements,
wherein each of the one or more secondary distributive mixing elements is positioned between a remaining secondary entrance port in the plurality of entrance ports and the exit port.

11. The multi-port single screw extruder of claim 1, wherein one or more of the first entrance port and the exit port are not aligned center-to-center with the heated plastication barrel.

12. A polymer compounding method comprising:
heating a plastication barrel above a compounding temperature of one or more first ingredients, the plastication barrel including:
a first entrance port;
an exit port,
wherein the first entrance port is positioned on the first end, and
wherein the exit port is positioned on the second end; and
at least one secondary entrance port positioned between the first entrance port and the exit port;
feeding the one or more first ingredients to the first entrance port;
adding one or more secondary ingredients through the one or more secondary entrance ports;
transmitting the one or more first ingredients and the one or more secondary ingredients along a length of the plastication barrel to a distributive mixing element;
mixing the one or more first ingredients and the one or more secondary ingredients, forming a mixture;
subjecting the mixture to a series of successive shear-strain events with the distributive mixing element to form a uniform homogenous flowable mass.

13. The method of claim 12, wherein transmitting the one or more first ingredients and the one or more secondary ingredients includes heating the one or more first ingredients and the one or more secondary ingredients to a temperature suitable for mixing.

14. The method of claim 12, wherein the flowable mass comprises a composition with a microscale morphology comprising structures with a major axis less than one micron in length.

15. The method of claim 12, wherein the transmitting is performed using a helical plastication screw positioned within the plastication barrel between the first entrance port and the exit port,
wherein the helical plastication screw includes one or more distributive mixing elements positioned between the at least one secondary entrance port and the exit port.

16. The method of claim 15,
wherein the helical plastication screw has a dynamic minor diameter along a length of the helical plastication screw, and
wherein the minor diameter is reduced in advance of each of the at least one secondary entrance ports, reducing the barrel pressure at each of the at least one secondary entrance ports, permitting the one or more ingredients to be fed into each of the at least one secondary entrance ports.

17. The method of claim 15, wherein the helical plastication screw includes a conveyor segment configured and positioned to receive and disperse the one or more ingredients from the plurality of hoppers.

18. The method of claim 12, wherein the one or more first ingredients includes one or more thermoplastic polymers.

19. The method of claim 12, wherein the plastication barrel further includes:
a distributive mixing element positioned between one of the at least one secondary entrance ports and the exit port.

20. The method of claim 12, wherein the transmitting further includes transmitting the one or more first ingredients and the one or more secondary ingredients along a length of the plastication barrel in a direction towards the exit port.
